(19) United States
(12) Patent Application Publication
(10) Pub. No.: US 2014/0070605 A1
(43) Pub. Date: Mar. 13, 2014

(54) Reciprocating energy, self recharging, alternating energy process

(71) Applicant: Michael Steven Hargett, Salem, OR (US)

(72) Inventor: Michael Steven Hargett, Salem, OR (US)

(21) Appl. No.: 13/507,297

(22) Filed: Sep. 13, 2012

(51) Int. Cl. B60L 11/12

(52) U.S. Cl. 307/9.1

(57) ABSTRACT

There is no documentation supporting perpetual motion, in the Laws of Physics by which govern the known universe.

The search for perpetual motion is on going, and has never been achieved.

This invention, utilizes today's technologies which allows us to come very close to this illusive property by reciprocating the electrical energy.

This invention uses manipulation and alteration of electrical current in a step up process.

This inventive step up process along with other technical means to recharge the energy storage devices in an alternating fashion, allows a longer drive time of the electrical load without interruption of service in recharging the energy storage devices in a plug in manor to an electrical power source. This invention eliminates the need of a plug in wire to recharge its energy storage devices.

### SUMMARY (I)

This present invention consist of means to store electrical power in electrical energy storage device (s), then release the stored electrical energy when needed to drive or power an electrical load.

The reciprocating energy process in this invention is to alter or manipulate a certain portion of the stored electrical energy as it is being sent to power or drive the electrical load, herein referenced as an electric vehicle. The storage device, (s) are on board the electric vehicle. Once altered the electrical current would be reintroduced back into the storage device (s), which is restored for future use.

The electrical energy is created by a Genset onboard the load or electric vehicle, herein mentioned in this inventive process is a genset. A Genset is a combination of a combustion engine an electricity producing device mated together mechanically to create electrical current to drive or power an electrical load. The Genset, when running creates and generates the electrical current which is stored and held then later released as needed to power or drive the load.

Note, in this invention the Genset's combustion engine can be fueled by a myriad of combustion able fuels to power the Genset. These combustion ale fuels to mention a few are, unleaded gasoline, natural gas, propane gas, ethanol fuel, hydrogen fuel, also including HHO—hydrogen, ie; brown gas.

### SUMMARY (II)

This inventive process can be scaled to produce and store several volts up to the production and storage of many kilowatts. The various degrees of electrical current is held, stored and later released as needed. The inventive process of alternating the use of the energy storage device, (s) gives a greater length of distance and time of service, by the use of store and release as needed of the electrical current to power or drive a load.

The manipulation, alteration of electrical current along with alternating the energy storage device,(s) use in the store and release of the electric current to drive or power the load, would yield even greater distance and time of service by reciprocating a portion of the electric current back into the energy storage device (s).

This invention references an electric vehicle in the discharge and recharge process of its energy storage device, (s) onboard the electric vehicle while driving. In addition to this current manipulation, alteration this invention also makes use of energy storage device (s) most commonly known as batteries in an alternating form of use in a discharge and a recharge sequence to continually allow the load to be driven without being taken out of service for recharging. The recharging normally would be completed with a electrical outlet, having to take the electric vehicle out of service and plug into the receptacle to recharge the energy storage device, (s) ie; batteries.

### SUMMARY (III)

This Invention incorporates the alternating use of the energy storage devices, ie; batteries powering the load or to drive a load, referenced herein as an electric vehicle. This invention alternates the use of the electrical storage device (s) ie; batteries. The discharge and recharge use is determined by the depletion level of the storage device, (s) in the powering or driving of the load.

The alternating process starts by taking the first storage device, (s) which is driving or powering the load. Once the first storage device is near depletion, the system switches use from number one, to number two storage device to power or drive the load. The number one storage device then enters a recharging phase, having been just relieved of its use in powering or driving the load. Once number one has been fully recharged, it is held on standby to re-enter the powering or driving of the load, once number two reaches a stage of depletion. Once number two is depleted, number one re-enters the powering or driving of the load. This alternating and recharging process cycles itself over and over on board the load, ie; herein referenced electric vehicle. The cycling process allows the electric vehicle to be continually driven without having to stop, taken out of service to have its energy storage device, (s) ie; batteries recharged.

### BRIEF DESCRIPTION OF DRAWING'S

FIG. 1),

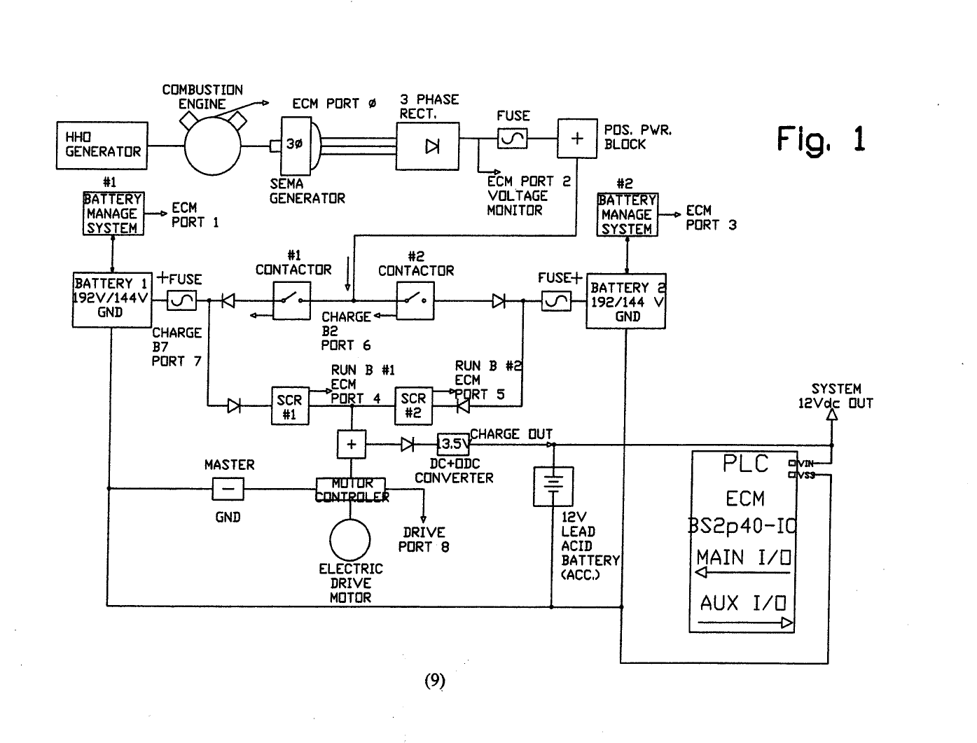

Shows the circuitry of the battery alternating recharging system, with components labeled.

FIG. 2).

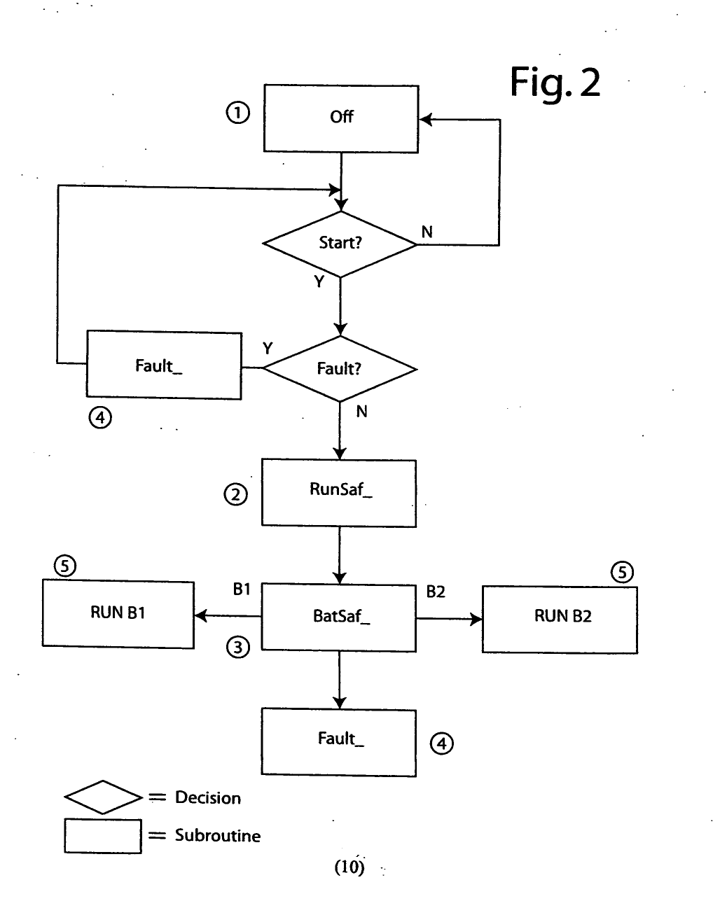

1. Sleep—When Ignition Key off, ECM will be in low power mode. ECM wakes up every second and checks on the Ignition Key status.
2 Pwr Saf—Insure all relays are in a safe condition.
3 BatSel—Choose a charged battery, If both are charged, use battery with the lowest hours of run time. If neither battery is charged go to “Fault”.
4 Fault—ECM detects problem, act accordingly and sets Error code.
5 Run Bat1 or Run Bat 2—Runs selected battery and charges the other battery.

### BRIEF DESCRIPTION OF THE INVENTION

This Invention relates to alternating the use of 2 or more electrical energy storage device's used in a discharge and recharge reciprocal process. To discharge one storage device to drive a load and have the other on standby charged to relieve the number one storage device upon depletion. The number 2 storage upon depletion of the number 1 storage device would then relieve the number 1 in powering the load.

The number 2 would be used in powering the load. Upon number 2 depletion, number 1 would be re-introduced in powering the load as number two would then enter the recharging phase.

The Invention also uses electrical equipment to alter the electrical current in the discharge and re-charge process. The alteration is termed step up and step down in electrical terminology. The Invention's description is the current used to power the load is altered in the use of the current to power the load and then re-alter it to store in the energy storage devices.

The alteration in the current in the step up and step down process allows the current to flow through the load and re-enter the flow and then be re-altered to restore in the energy storage devices. This phase in the electrical field is called the unbalanced load. The unbalanced load is re-altered for storage and then held for later use in the reciprocal process.

### DESCRIPTION OF PRIOR ART

Storage Device Alternating Recharging Process; Ser. No. 12/228,855 #20100039070 Filed Feb. 18, 2010

Electrical Energy Source; U.S. Pat. No. 7,511,451 Mar. 31, 2009, application Ser. No. 11/480,350 Filed Jul. 5, 2006

1. A power generating system for an electric powered vehicle, utilizing an electrical system for stepping up electrical current as it is being sent to drive the electric vehicle. The step up system is comprised of an electrical device named a step up boost converter this device alters a portion of current that is being sent from the battery to the electric drive motor which drives the electric vehicle. Also included in this sequence of current step up process is and inverter, the stepped up current is inverted and then sent back to the battery.
A voltage regulator is in place to set the voltage which matches the battery pack voltage. This portion of current in which is stepped up and sent through this process is redirected back to the batteries. There are (2) battery packs. These battery packs store electrical energy which supplies the current that drives the electric vehicle. The electrical current that is stepped up replaces a portion used to drive the load from the (1) battery which is being used to drive the electric vehicle.
The stepped up current in voltage helps replace the electrical draw taken from the batteries in which drives the load, ie electric vehicle. This step up in current does replace a certain portion of current that is being used to power the vehicle.

2. An electricity generating device placed onboard the electric vehicle to generate electricity to recharge the battery packs as they are being used in an alternating fashion to drive the electric load ie electric vehicle. This electricity generator ie genset is powered by unleaded fuel for generating electricity. The system has (2) separate battery packs and the batteries are used in a sequence of charge and discharge. One battery will be driving the load and the other battery is being placed on standby. As one battery is depleted it is sent into a recharging phase. The electric vehicle then switches to the other battery pack to start driving the load. This battery alternating recharging process utilizes a specific battery recharging electrical circuits connecting said generating device and battery packs including a first switch for selectively recharging first and second battery packs through the battery recharging electrical circuits, respectively.
electrical driving circuits coupled to said electric motor and said battery packs including a second switch for electrically driving electric drive motor using stored electrical energy (i) from first battery pack when first switch connects said generating device and second battery pack and second switch connects electric drive motor and first battery pack and from second battery pack when first switch connects
electricity generating device and first battery pack and second switch connects electric drive motor and battery packs.

3. HHO, brown gas hydrogen generator placed onboard the electric vehicle is used to generate brown gas HHO ie hydrogen to power the electricity generating system ie genset which generates the electricity the recharge the batteries in the alternating recharging system. This brown gas ie HHO or hydrogen is derived from a tank that is storing H2O, water also onboard the electric vehicle. The HHO; brown gas hydrogen generator is powered from the stored electrical energy in the drive batteries. The current needed to create this HHO; brown gas is a minimum of 20 volts from the battery system itself. This electrical current is then replaced in the recharging phase of the system.
